(19) United States
(12) Patent Application Publication
(10) Pub. No.: US 2006/0246183 A1
(43) Pub. Date: Nov. 2, 2006

(54) Method of containing peas and container therefore

(76) Inventors: Yves Marie Bernard Bonnefous, Amstelveen (NL); Carl Lewis Gibbard, Shambrook (GB); Christopher William Goodsall, Shambrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/560,627

(22) PCT Filed: Jun. 2, 2004
(86) PCT No.: PCT/EP04/05968

§ 371 Date: Jun. 5, 2006

(30) Foreign Application Priority Data
Jun. 12, 2003 (GB) 0313668.6

(51) Int. Cl. A23B 7/148

(52) U.S. Cl. 426/106

(57) ABSTRACT

A method of containing peas is provided comprising the steps of providing a container (1) mounted on a vehicle (11) and containing a pea load, maintaining the concentration of oxygen at or above 15% by volume throughout the container (1) and maintaining the concentration of carbon dioxide at or below 1% by volume throughout the container (1). Also provided are a container (1) for use in the method and a method of processing peas employing such a container.

The present invention relates to a method of containing peas, particularly for storage or for transportation, so as to reduce deterioration of the quality of the product after harvesting.

Perishable products such as vining peas are generally harvested from the fields by mechanically vining the peas to separate them from the pods and then transported to a factory at a different location for processing, for example for freezing and packaging. Generally the load is transported from field to factory in a container located on a lorry. The container may be a simple storage bin covered by a lid or tarpaulin to protect the produce from rain and contamination.

The quality of the fresh produce can deteriorate post-harvest, during storage and transportation. It is therefore desirable to minimise the time taken from harvesting to processing the raw material, to ensure that a high quality product can be produced. Known methods of storing and transporting the produce can result in high wastage if the lorry is delayed on its journey, since the manufacturer may not wish to use the resultant lower quality product.

The known method has a further disadvantage in that it restricts the location of the fields in which the peas may be grown, since they must be within a certain distance of the factory.

in pea processing, it is known to impose time limits on processing to ensure a good quality product. For example, a maximum of 90 minutes can be allotted for transportation of the peas from the harvest to the factory, and the total processing time, from time of harvest to time of freezing should take no longer than 150 minutes. Peas may not be included as premium quality if these time restrictions are not met.

It is known that the atmosphere in which fruit or vegetable produce is contained can affect the condition of the product, and efforts have been made to condition the atmosphere. EP-A-0292834 discloses a method of storing fruits and vegetables in an atmosphere which is controlled to have a low oxygen content and a high carbon dioxide content, and which has a total pressure less than atmospheric pressure. EP-A-0294036 discloses a method of storing perishable produce, such as harvested fruit, vegetables and cut flowers, in a storage container, wherein the atmosphere in the container is nitrogen-enriched and oxygen reduced, so as to minimise ageing of the product. Neither of these references refers to the storage of peas.

It is an object of the present invention to provide an improved method of storing and transporting freshly harvested peas.

According to a first aspect of the present invention, a method of containing peas which comprises introducing peas into a container, maintaining the concentration of oxygen at or above 15% by volume throughout the container and maintaining the concentration of carbon dioxide at or below 1% by volume throughout the container. The container is mounted on a vehicle.

The invention provides a simple and effective means of slowing the deterioration of the product over time compared with known methods of transportation. Accordingly, the invention may provide the advantage that peas can be stored for a given length of time resulting in a higher quality product compared with known containment methods. Alternatively, the peas can be stored for longer periods of time maintaining a high quality product.

It is known that metabolism of the peas continues after harvesting, thus consuming oxygen in the atmosphere in the container and generating some carbon dioxide. As the oxygen concentration decreases, anaerobic fermentation in the peas increases generating more carbon dioxide. Accordingly, oxygen levels decrease and carbon dioxide levels increase in the load.

It is believed that the anaerobic fermentation is responsible for the deterioration of the quality of the peas. It has been found that, by maintaining a sufficiently high oxygen level and low carbon dioxide level around the metabolically active peas during storage and transportation, deterioration of the peas can be prevented.

The oxygen concentration may be maintained by establishing a continuous gas flow, for example airflow, relative to the peas. The gas flow may be established by using pumps, fans or the like to blow gas through the fresh pea product. It has been found that a gas flow rate of between 600 L min⁻¹ and 16000 L min⁻¹ flowing through each square metre of the load in a plane generally perpendicular to the air flow, for example flowing upwardly through each square metre of the base of the container supporting the load, can maintain the oxygen and carbon dioxide concentration at appropriate levels. Preferably, the flow rate is between 1000 L min⁻¹ m⁻² and 14000 L min⁻¹ m⁻², more preferably between 1280 L min⁻¹ m⁻² and 12800 L min⁻¹ m⁻². Even more preferably, the flow rate is between 1280 L min⁻¹ m⁻² and 6000 L min⁻¹ m⁻², Too high an airflow should be avoided to prevent drying of the peas.

Alternatively, the peas may be moved relative to the gas, for example by a tumbling action. In one embodiment, the movement of the container, for example by movement of the lorry, causes air to be distributed or circulated around the peas, This has the advantage that no separate pump or fan is required.

According to one embodiment, the container can be provided with a conduit having an inlet in communication with the outside atmosphere and an outlet in communication with the interior of the container. When the container is mounted on a vehicle, the inlet preferably faces the forward direction of travel of the vehicle, thus causing air to flow from outside the container to the interior of the container when the vehicle is moving.

This embodiment of the invention is particularly advantageous since no moving parts are required, it being the movement of the container caused by the movement of the vehicle that maintains the oxygen concentration. Particularly good results may be achieved if the outlet of the conduit is positioned near the bottom of the container, so as to cause air to flow in an upward direction through the pea load. This ensures that entire the load is aerated.

It has been found that a cross sectional area (C) of between approximately 0.072 m² and 0.13 m² for the inlet of the conduit can sufficiently aerate the pea load. A conduit having a cross sectional area between these values takes in enough air, for vehicle speeds between 4.7 ms⁻¹ (10 mph) and 26.3 ms⁻¹ (56 mph), to provide a flow rate of between 1280 L min⁻¹ m⁻² and 12800 L min⁻¹ m⁻². In has been found that only about 50% of the air flowing over the vehicle towards the conduit actually enters the conduit. This has been taken into consideration when calculating the above figures. A more general relationship has been derived for the relationship between the area of the tank-floor (F) and the duct-inlet cross sectional area (C). To meet minimum air-flow requirement, the cross sectional area must satisfy Cₘᵢₙ=0.00454×F, for maximum air-flow the relationship is Cₘₐₓ=0.00811×F.

in order to ensure an even flow rate it is preferable that electric powered fans are used during periods when the vehicle is stationary or moving at less than 10 mph. Suitable fans operating at 12 or 24 V are well known in the art.

The container may comprise a main part to receive the peas and a cavity to receive the outlet of the conduit. A partition may separate the cavity and the main part and may allow gases such as oxygen and air to flow from the cavity into the main part. In this way, an even distribution of airflow or oxygen flow through the product can be obtained. The cavity may be formed on one side of the container, but preferably it is formed at the bottom of the container.

The partition may be formed from a food grade, plastic material, which, advantageously, is hard wearing. It is beneficial if the partition can be easily cleaned. The partition may be porous, and preferably is formed with pores in the form of holes which are distributed over the partition to allow an even airflow across the surface of the material without creating back pressures thereby allowing free airflow through the partition. The partition may comprise a perforated sheet of metal or plastics material. Alternatively, the partition may be formed from another hydrophobic material. This can also reduce the likelihood of liquid clogging the holes.

A suitable material is VYON®, a porous plastic material produced by Porvair. VYON® can have various thicknesses and pore sizes. For example, the thickness can be from 7.5×10⁴ m to 100×10⁻⁴ m. The pores may have diameters between 2×10⁻⁶ m and 300×10⁻⁶ m. Preferably, the pores have an average diameter of 98×10⁻⁶ m. VYON® can be formed from different materials, such as high density polyethylene, ultra high molecular weight polyethylene or polypropylene.

Preferably the material is stainless steel perforated to a density of 50% with 300 μm pores.

The container may have an opening, for example in an upper surface, which can be provided with a removable cover. The cover must allow the flow of gas between the container and the outside atmosphere. In this way, the build up of pressure within the container is avoided. The cover may be porous or perforated or separated slightly from the container. Alternatively, the container may be formed with one or more openings which are not under the cover.

In a further embodiment, the container can be agitated, or can be provided with a part that may be agitated, to generate an airflow relative to the peas. For example, the container or a part thereof may rotate along a generally horizontal or slightly inclined axis so as to cause the peas to tumble. The container may have ribs or baffles formed on its interior surface which lift the peas as the container rotates. This can result in improved aeration of the peas. This embodiment may operate in much the same way as a cement mixer. This method of aerating the peas has the advantage that the level of oxygen in ambient air is maintained around the peas.

The container may be in fluid communication with the outside atmosphere, for example by way of a conduit or an opening in the container. Optionally, the opening may be guarded by a removable cover, which allows the flow of gas between the container and the outside atmosphere, and prevents loss of produce and entry of foreign material.

In all embodiments, the oxygen or air to be distributed throughout the pea load may first be humidified. Methods of humidifying oxygen and air known to those skilled in the art may be used, for example by passing the gas through water or by way of an aerosol device. This prevents the flow of oxygen or air having a drying effect on the peas, which can reduce the flavour, texture and quality in general of the peas.

A filter may be used to filter the oxygen or air before it is distributed throughout the pea load. This is particularly advantageous where air flows from outside the container into the container due to the movement of the vehicle, since impurities such as dust and insects need to be removed.

The concentration by volume of oxygen in the air throughout the pea load is maintained at or above 15%. It is further preferred that the concentration by volume of oxygen throughout the pea load is maintained at or above 18%. It is particularly preferred that the concentration by volume of oxygen throughout the pea load is maintained at or above ambient level, i.e. approximately 20.9% by volume. These levels can readily be achieved using ambient air, although oxygenated air may be employed.

The concentration by volume of carbon dioxide throughout the pea load is maintained at or below 1% by volume. It is further preferred that the concentration by volume of carbon dioxide throughout the pea load is maintained at or below 0.25%. It is particularly preferred that the concentration by volume of carbon dioxide throughout the pea load is maintained at or below ambient level, i.e. approximately 0.03%. The defined levels of carbon dioxide can readily be achieved by aeration.

It is also preferred that the concentrations of gases other than oxygen and carbon dioxide are maintained at or below ambient level, e.g. the ambient level of carbon monoxide is less than 10 ppm. These levels can readily be achieved by aeration. Preferably also, the total pressure of gas within the container is between 0.9 and 1.2 atm absolute pressure.

The method and apparatus of the present invention are suitable for use with both refrigerated and unrefrigerated pea loads. In order to avoid excessive condensation of moisture onto the pea load it is preferable, however, that the pea load is unrefrigerated such that the pea load has a temperature about the same as the ambient air temperature, e.g. between 5 and 40° C., preferably between 10 and 35° C., more preferably between 15 and 25° C.

Thus the present invention provides an improved method of storing and transporting peas without the need for utilising gas-tight containers or employing complex process steps such as purging the container with air enriched with carbon dioxide.

Embodiments of the present invention will now be described by way of a number of examples, with reference to the following Figures, in which

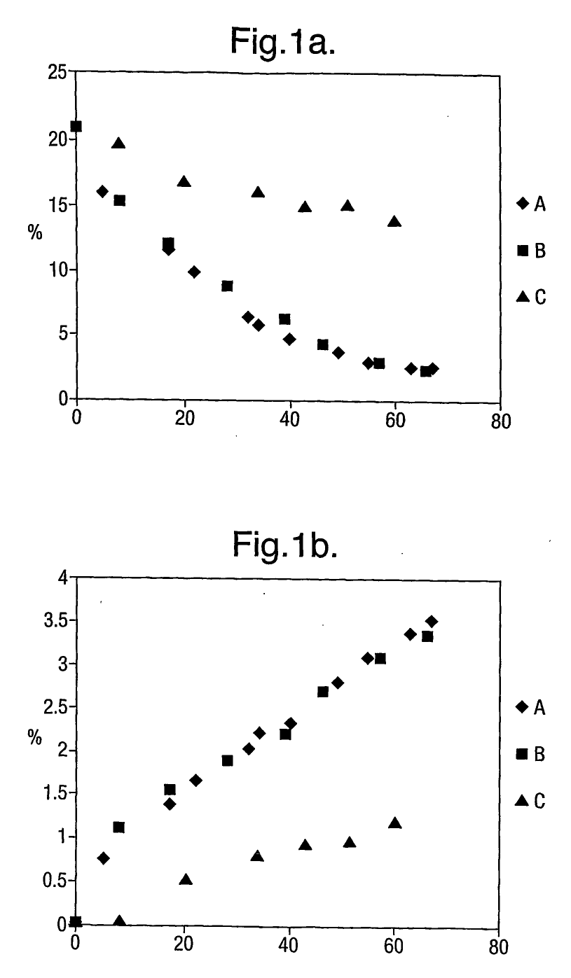

FIG. 1a is a graph showing the oxygen level surrounding the peas in a pea load transported using the known method;

FIG. 1b is a graph showing the carbon dioxide level surrounding the peas in a pea load transported using the known method;

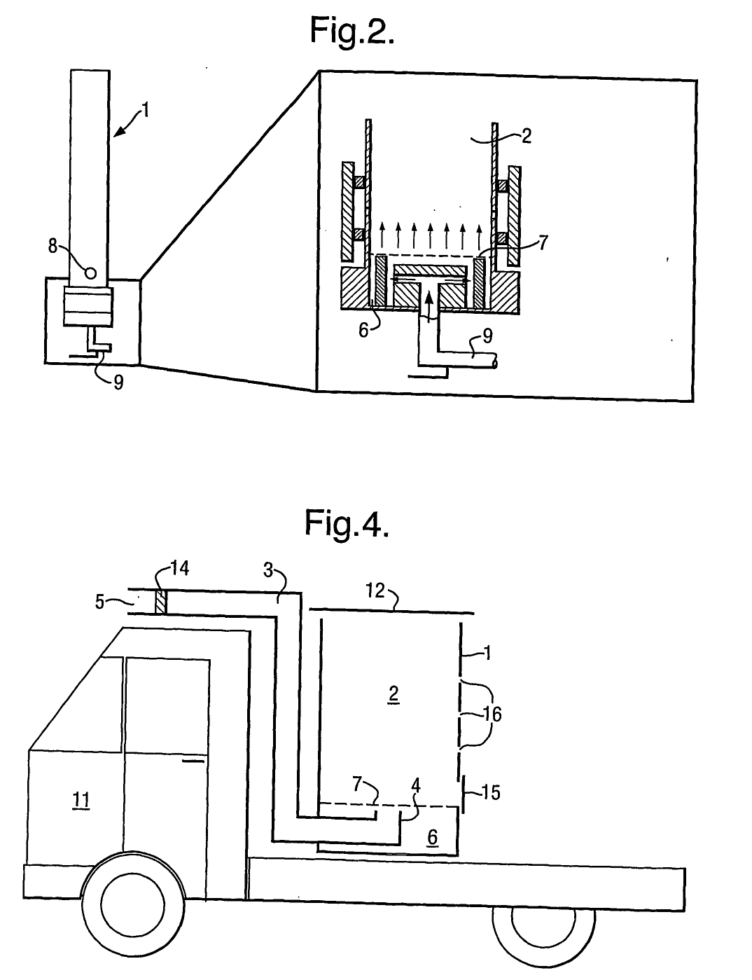

FIG. 2 is a schematic diagram of a container suitable for use in the present invention;

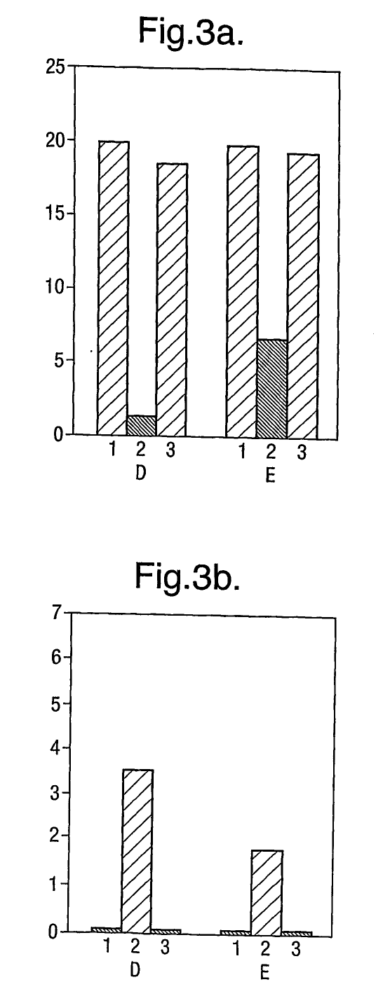

FIG. 3a is a graph showing the oxygen level in the container of FIG. 2 compared with the oxygen level in a similar container which is not aerated;

FIG. 3b is a graph showing the carbon dioxide level in the container of FIG. 2 compared with the carbon dioxide level in a similar container which is not aerated;

FIG. 4 is a schematic diagram of another container for use in the present invention, which is mounted on a vehicle;

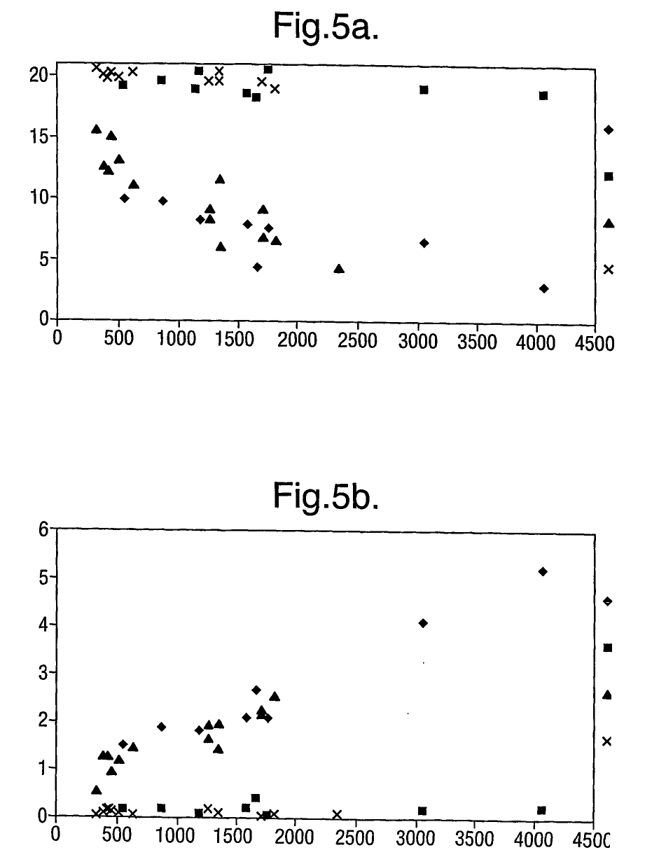

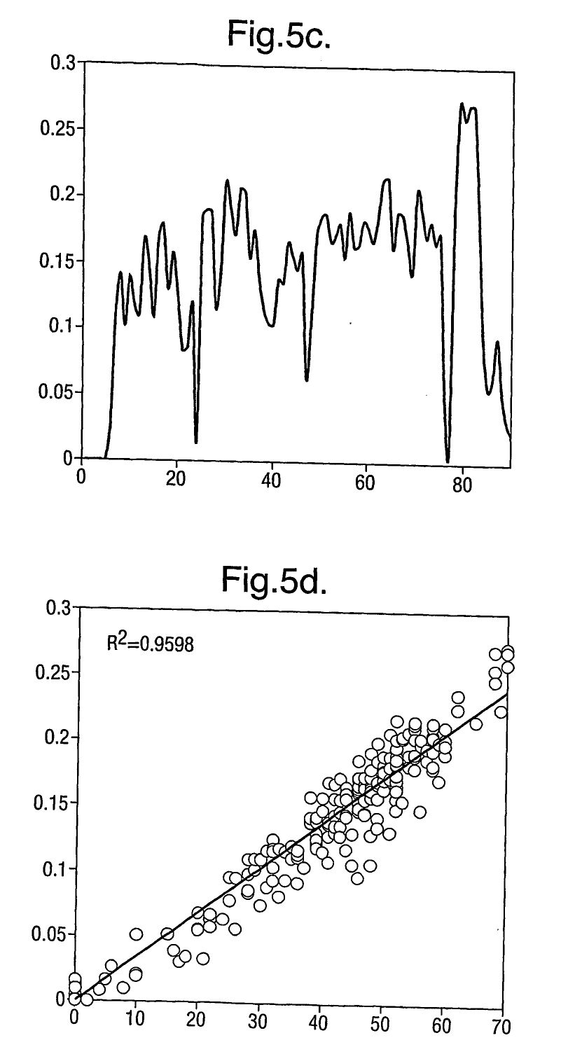

FIG. 5a is a graph showing the final oxygen level in various pea loads;

FIG. 5b is a graph showing the final carbon dioxide level in various pea loads;

FIG. 5c is a graph showing the air flow rate through a pea load aerated in a container according to FIG. 4;

FIG. 5d is a graph showing the correlation between air flow rate through the pea load of FIG. 5c and the speed of the vehicle carrying the pea load;

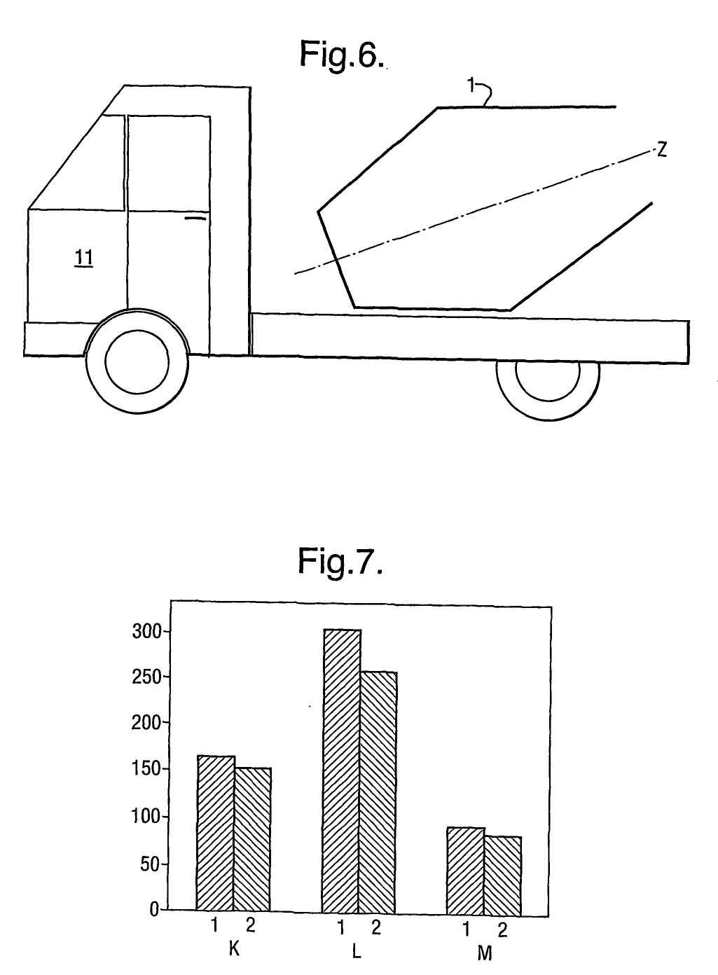

FIG. 6 is a schematic diagram of another container for use in the present invention.

FIG. 7 is a graph showing ethanol content after processing

As a first, comparative example, the oxygen and carbon dioxide levels of two commercial pea loads were monitored from the field to the factory. Peas of the Waverex variety were harvested and then introduced into a known pea transporter. Approximately 2500 kg of peas were placed in the transporter. A gas sampling lance, which is described in more detail below, was inserted and positioned near the bottom of the load, at a depth of 60 cm. A 50 ml gas sample was then taken and a timer was started. The pea load was then transported to a factory and further 50 ml gas samples were taken at various times during the journey, the final one being at the factory. The gas samples were then analysed using a Gaspace 2 Analyser (model ZR869, available from Systech Instruments, Thame, England) to determine the oxygen and carbon dioxide levels.

Another known pea container was filled with peas of the Barle variety. The peas were transported and gas samples were taken in the same way as described above. However, in this case, two gas sampling lances were used, one at a depth of 90 cm and one at a depth of 5 cm. The Barle load was deeper than the Waverex load.

The gas sampling lance was used to take samples of gas from within the pea load for later analysis. The lance comprised a rigid plastic tube, 180 cm in length and 35.7 mm in diameter, and had a cone-shaped plug attached to the distal end. A tube, 300 cm in length and 1.57 mm in internal diameter was fed through the outer tube to the cone plug. A 560 cm extension portion terminating in the cab of the vehicle, having a switcher, a pump and a 50 ml sampling syringe associated therewith, was added to enable gas samples to be taken from the container during transit. The gas samples were analysed for oxygen and carbon dioxide content after the journey, using the Gaspace 2 Analyser.

The results of the above two experiments are shown in FIGS. 1a and 1b. FIG. 1a shows the variation in oxygen level with journey time and FIG. 1b shows the variation in carbon dioxide with journey time. In each Figure, concentration of oxygen or carbon dioxide respectively is plotted on the y-axis, and time in minutes is plotted along the x-axis.

Data series A represents measurements of oxygen and carbon dioxide concentration respectively at the depth of approximately 60 cm, for the pea variety “Waverex”;

Data series B represents measurements of oxygen and carbon dioxide concentration respectively at the depth of approximately 90 cm, for the pea variety “Barle”;

Data series C represents measurements of oxygen and carbon dioxide concentration respectively at the depth of approximately 5 cm, for the pea variety “Barle”.

It can be seen from FIG. 1a that the initial oxygen concentration for all three data series was generally equal to that in ambient air. However, the concentration near the bottom of the load decreases rapidly with time for both the Waverex and Barle pea varieties. After 60 minutes, the oxygen concentration was 85% less than the initial concentration. It can be seen that the results for the two varieties are very similar.

The concentration near the top of the Barle load also decreased with time. After 60 minutes, the oxygen concentration had dropped by 32%. It appears that aeration naturally occurs to a small extent in the top level of the load.

It can be seen from FIG. 1b that the concentration of carbon dioxide was found to increase significantly with time. Near the bottom of the pea load, the carbon dioxide concentration after 60 minutes was 110 times the initial concentration.

A second example employed the apparatus shown in FIG. 2. This apparatus is suitable for use in the present invention on a small, experimental scale. The container 1 is an upright tube capable of containing peas to a similar depth as a normal load. A plastic container having a height of 100 cm and an internal diameter of 100 mm was used. The container has a cavity 6 at its bottom, and a partition 7 separating the cavity 6 and a main part 2 of the container and upon which the peas are loaded. The partition 7 is formed from a grid, mesh or porous material so as to allow the flow of gas from the cavity 6 to the main part 2 of the container. A preferred material is VYON®, a porous plastic material produced by Porvair. In this apparatus, VYON® HP was used, having a thickness of 2.5±0.25 mm and an average pore size of 98×10⁻⁶ m.

The container 1 has an opening 8 adjacent or near the partition 7 for a syringe or other apparatus to be inserted. This enables samples of gas to be taken from near the partition 7, enabling the determination of the level of oxygen, carbon dioxide or other components of the gas. A 50 ml syringe was used to take gas samples, and the samples were analysed using a Gaspace 2 analyser.

A line 9 from a compressed air bottle (not shown) has an outlet in the cavity 6 and allows air to pass from a bottle to the cavity 6. The air passes through the porous partition 7 and aerates the peas from below, maintaining the level of oxygen around the peas. Oxygen or oxygenated air could also be used to maintain the oxygen concentration throughout the pea load.

A control container which had an identical structure, but which was not connected to a gas supply was used as a control.

In a first part of this experiment, both containers were filled with 10 kg of freshly harvested peas of the Bikini variety to a depth of 100 cm, and a sample of gas was immediately taken from each. One container was aerated by an airflow rate of approximately 5 litres per minute. A gas sample was then taken from each container after 120 minutes.

In a second part of this experiment, both containers were filled with 10 kg of freshly harvested peas of the Novella variety to a depth of 100 cm, and a sample of gas was immediately taken from each. One container was aerated by an airflow rate of approximately 5 litres per minute. A gas sample was then taken from each container after 75 minutes.

The results obtained for these experiments are shown in FIGS. 3a and 3b. Oxygen levels are shown in FIG. 3a and carbon dioxide levels are shown in FIG. 3b. The results for the Bikini variety are labelled D and the results for the Novella variety are labelled E.

Column 1 shows the oxygen or carbon dioxide levels respectively in the gas samples taken at the start;

Column 2 shows the oxygen or carbon dioxide levels respectively in the control gas samples taken at the end of the experiment;

Column 3 shows the oxygen or carbon dioxide levels respectively in the aerated gas samples taken at the end of the experiment.

It can be seen that, at the end of the experiment, the level of oxygen near the bottom of the aerated container is generally the same as the initial level. In comparison, the level of oxygen near the bottom of the control container is much lower at the end of the experiment. Similarly, the results show that the level of carbon dioxide in the container can be greatly reduced by aerating the container.

A third example illustrates how the present invention can be used on a larger scale. The apparatus shown in FIG. 4 comprises a container 1 which has a 50 cm×50 cm square base and a height of 75 cm. The container was formed from plastic, although other rigid materials such as metal would also be suitable. The container 1 is mounted on a vehicle 11 to allow peas to be transported therein from the field to the factory. The container 1 has a cavity 6 at its bottom and a partition 7 upon which the peas are loaded. The peas are therefore contained in the main part 2 of the container 1.

The partition 7 is formed from a grid, mesh or porous material so as to allow the flow of gas from the cavity 6 to the main part 2. A preferred material is VYON®, a porous plastic material produced by Porvair. In this apparatus, VYON® HP was used, having a thickness of 2.5±0.25 mm and an average pore size of 98×10⁻⁶ m.

The container 1 has a cover 12 that is preferably removable. The cover 12 is positioned so as to allow air to escape the container 1, thus avoiding a build up of pressure, and also to prevent the accumulation of rainwater in the container. Accordingly, the cover 12 can be positioned slightly above the container 1, or the top of the container 1 can be formed with one or more openings. The cover 12 may be made from a rigid material such as plastic or metal, or may be a tarpaulin.

A conduit 3 has an inlet 5 facing the forward direction of travel of the vehicle, and an outlet 4 inside the cavity 6. The forward movement of the vehicle 11 therefore causes air to flow through the conduit 3, into the cavity 6 and through the porous partition 7 into the pea load.

The conduit 3 optionally has a filter 14 to filter dust particles, Insects or other impurities from the air. Additionally, the conduit 3 can have an anemometer and a device, such as an aerosol device, to humidify the incoming air.

An opening, such as a hatch 15, may be formed in a wall of the container, adjacent or near the partition 7, to allow peas to be removed from the container. Further openings 16 are formed in the wall of the container to allow one or more sampling tubes to be inserted into the container to draw gas samples. The tube is preferably made of plastic and has a length of 25 cm and an internal diameter of 6 mm.

Two containers as shown in FIG. 4 were filled with approximately 80 kg of freshly harvested peas to a depth of 70 cm. Covers were positioned on the containers and gas samples were taken from both. The peas in one container were then aerated. A calibrated anemometer (AV6 Digital Handheld Vane Anemometer supplied by Airflo™, Lancaster road, High Wycombe, Bucks. UK) was fixed in-line with the vent and ducting at the base of the pea container that was aerated. The vehicle speed and airflow were recorded at 30-second intervals throughout the trial. Both containers were transported to the factory. Further gas samples were taken from each container during the journey, the final samples being taken on arrival at the factory. The ambient temperature was noted each time a gas sample was taken.

To provide a comparison, two containers as shown in FIG. 2 were filled with peas. One container was aerated and the other was not. Gas samples were taken from each container at various times, and the ambient temperature was recorded simultaneously.

The variation of oxygen and carbon dioxide levels in this example are shown in FIGS. 5a and 5b respectively. The oxygen and carbon dioxide levels are shown along the y-axis, and the duration of the journey (in minutes) multiplied by the ambient temperature (in degrees centigrade) is shown along the x-axis.

Data series F refers to readings taken from a control container according to FIG. 4;

Data series G refers to readings taken from an aerated container according to FIG. 4;

Data series H refers to readings taken from a control container according to FIG. 2;

Data series J refers to readings taken from an aerated container according to FIG. 2.

It can be seen from FIGS. 5a and 5b that, by aerating peas contained in the apparatus shown in FIG. 2 or FIG. 4 a high, approximately ambient level of oxygen and a reduced level of carbon dioxide can be maintained in the peas.

It has been found that an increased temperature in the pea load contributes to oxygen depletion within the load. Accordingly, passing air or oxygen through the pea load may additionally help maintain the quality of the peas by cooling the pea load.

The airflow through the peas in an aerated container according to FIG. 4 is shown in FIG. 5c. The flow rate is shown on the y-axis (in m³ s⁻¹ m⁻²), and the duration of the journey is shown along the x-axis (in minutes). The correlation between the airflow through the peas in an aerated container according to FIG. 4 and the speed of the vehicle is shown in FIG. 5d. The flow rate is shown on the y-axis (in m³ s⁻¹ m⁻²), and the speed of the vehicle is shown along the x-axis (in mph). It can be seen that the flow rate varied considerably throughout the trial and that this variation is owing to the variable speed of the vehicle. Thus, in order to ensure a more even flow rate it is preferable that electric powered fans are used during periods when the vehicle is stationary or moving at less than 10 mph.

It is to be understood that the apparatus shown in FIG. 4 could be adjusted to have different dimensions. A structurally similar but larger container could be used to transport commercial loads.

FIG. 6 shows a further embodiment of the present invention, in which the peas are aerated by tumbling them in a rotating container 1. The container rotates about the slightly inclined axis, Z, although a generally horizontal axis could also be used. No mechanism to cause air to flow through the pea load is required, since tumbling the peas aerates the load sufficiently.

According to a fourth example, the apparatus of FIG. 2 was used to determine and compare the ethanol content of aerated peas with the ethanol content of non-aerated peas. Ethanol content is a typical product of anaerobic oxidation (eg in brewing), and the level will indicate the effectiveness of the aeration treatment in maintaining the condition of the harvested peas. Experiments were conducted in which one container of peas was aerated and another, control container, was not.

In Experiment K, Bikini peas were stored for 120 minutes at a temperature of 21° C.

In Experiment L, Novella peas were stored for 120 minutes at a temperature of 28.5° C.

In Experiment M, Novella peas were stored for 75 minutes at a temperature of 15.8° C.

At the end of each experiment, approximately 1.5 kg of peas was taken from the bottom of the both the aerated container and the control container. These samples were washed, blanched in Netlon bags and frozen (−35° C.). 10 g of each sample were placed in 10 ml of cold water (4° C.) and macerated using an Ultra Turrax (maximum speed). The slurry from each sample was then centrifuged for 20 minutes at 12,000 g and the supernatant collected as an extract. A YSI 2700 Select biochemistry analyser (black electrode, standard recommended setting) (available from Analytical Technologies, Famborough, England) was used to assess the level of ethanol in each extract.

The results of this example are shown in FIG. 7. Ethanol content in parts per million is indicated along the y-axis. The results for each Experiment are labelled K, L and M respectively. Column 1 shows the ethanol level in the control peas and Column 2 shows the ethanol level in aerated peas.

As can be seen, the ethanol content of the non-aerated samples is greater than that of the aerated samples. It is believed that the ethanol content in non-aerated peas is actually much greater than that in aerated peas prior to blanching, but that the ethanol is washed out during blanching.

It can be seen from the results that storage time and temperature has an effect on the amount of ethanol produced. The Novella peas of Experiment L produced more ethanol than the peas in the other two experiments, since they were stored for longer at a higher temperature. Similarly, the peas in Experiment M produced less ethanol, since the storage time was relatively short and the temperature was much lower.

Additionally, the difference in ethanol content between the non-aerated sample and the aerated sample is greater in Experiment L than in Experiment K, which is in turn greater than in Experiment M.

These experiments demonstrate that aeration effectively reduces anaerobic fermentation and therefore ethanol production is suppressed. Also, aeration may have a cooling effect that lowers the temperature of the peas, due to evaporative cooling effects that also suppress fermentation.

Two trained pea tasters tasted peas from each of the three Experiments, to determine whether the treatment improved quality of the produce post harvest. In respect of Experiment K, the aerated peas were preferred. In respect of Experiment L, the aerated peas were preferred and a very clear difference was detected. In respect of Experiment M, no overall preference was found.

It is understandable that there was no overall preference in Experiment M. As mentioned above, the conditions in which the peas were stored, namely low temperature and for a short period of time, meant that quality loss was not as rapid compared with conditions of higher temperature or longer storage periods. In all embodiments it is preferable that the storage period is between 10 and 240 minutes. More preferably the storage period is less than 120 minutes and ideally less than 90 minutes.

In any of the above embodiments, the air or oxygen used to maintain the oxygen levels can be humidified so as to avoid a drying effect.

1. A method of containing peas comprising the steps of providing a container mounted on a vehicle and containing a pea load, maintaining the concentration of oxygen at or above 15% by volume throughout the container and maintaining the concentration of carbon dioxide at or below 1% by volume throughout the container.

2. A method of containing peas according to claim 1, wherein a conduit is provided having an inlet in communication with the outside atmosphere and an outlet in communication with the interior of the container.

3. A method of containing peas according to claim 2, wherein the inlet faces the forward direction of travel of the vehicle.

4. A method of containing peas according to claim 2, wherein the outlet of the conduit is positioned near the bottom of the container.

5. A method of containing peas according to claim 2, wherein the container comprises a main part to receive the peas and a cavity to receive the outlet of the conduit, the cavity being formed at the bottom of the container and being separated from the main part by a gas permeable partition.

6. A method of containing peas according to claim 1, wherein at least a part of the container rotates about an inclined axis.

7. A method of containing peas according to claim 1, wherein a fan establishes a gas flow through the peas.

8. A method of containing peas according to claim 1, wherein a gas flow rate, flowing through each square metre of the pea load in a plane generally perpendicular to the air flow, is between 600 L min⁻¹ and 16000 L min⁻¹.

9. A method of containing peas according to any claim 1, wherein a gas flow rate, flowing through each square metre of the pea load in a plane generally perpendicular to the air flow, is between 1000 L min⁻¹ and 14000 L min⁻¹.

10. A method of containing peas according to claim 1, wherein the container has an opening which is provided with a removable cover and which allows the flow of gas between the container and the outside atmosphere.

11. A method of containing peas according to claim 1, wherein the concentration of oxygen throughout the pea load is maintained at or above atmospheric air levels.

12. A method of containing peas according to claim 1, wherein the concentration of carbon dioxide throughout the pea load is maintained at or below atmospheric air levels.

13. A container for containing peas provided with means for establishing a gas flow through the container to maintain the oxygen concentration at or above 15% by volume throughout the container and the carbon dioxide concentration at or below 1% by volume throughout the container; the container being mounted on a vehicle.

14. A container for containing peas according to claim 13, the container comprising a main part, in which in use the peas are received, and a cavity, the main part and the cavity being separated by a gas permeable partition, the container being provided a conduit having an inlet and an outlet, the outlet being located in the cavity and the inlet being located outside the container.

15. A container for containing peas according to claim 14, wherein the inlet of the conduit faces the forward direction of travel of the vehicle.

16. A container according to claim 13, containing peas, wherein at least a part of the container rotates about a slightly inclined axis.

17. A method of processing peas including the steps of harvesting peas, introducing the peas into a container according to claim 13, transporting the peas to a processing station, blanching the peas and freezing the peas.

18. A method of processing peas according to claim 18, wherein the peas are then packaged.
